(19) United States
(12) Patent Application Publication
(10) Pub. No.: US 2026/0026483 A1
(43) Pub. Date: Jan. 29, 2026

(54) FLYING FISH LURE

(71) Applicant: Nomad Tackle Pty Ltd, Brendale (AU)

(72) Inventor: Damon OLSEN, Newport (AU)

(21) Appl. No.: 18/707,568

(22) PCT Filed: Oct. 31, 2022
(86) PCT No.: PCT/AU2022/051308

§ 371 Date: May 3, 2024

(30) Foreign Application Priority Data
Nov. 4, 2021 (AU) 2021903526

(51) Int. Cl. A01K 85/08; A01K 85/00; A01K 93/00

(52) U.S. Cl. CPC A01K 85/08; A01K 85/029; A01K 85/1817; A01K 93/00

(57) ABSTRACT

A flying fish lure for fishing, the lure having a body and at least two flat elongate appendages, shaped as flying-fish wings, attached to the body to approximate the appearance of a flying fish, wherein the body and the appendages are constructed so that the lure floats. The appendages may be separately manually removeable. The lure may be shaped to allow a realistic gliding or flying motion when towed or otherwise pulled. The shape and profile of the body and appendages, particularly where in contact with the water, has been adapted to improve the realistic nature of the movement of the lure through water.

### TECHNICAL FIELD

Embodiments relate to fishing lures and, in particular, fishing lures in the shape of a flying fish.

### BACKGROUND

Fishing lures are intended to mimic the prey which fish feed on. The more realistic the mimicry, the more likely it is that the lure will catch a fish. Different fish feed on different prey and many different types of lures exist to mimic different types of prey including other fish, flies and other insects, crustaceans etc.

The mimicry is not limited to the shape and appearance of the prey; efforts have also been made to emulate the behaviour of the prey, particularly the movement of that prey through the water. For example, spinnerbait is a tackle which includes a blade which when moved through the water, causes the bait to spin. The spinning blade, which is often made of metal, creates a visual mimicry of the prey fish moving through the water. Furthermore, the movement of the spinning blade through water creates turbulence which the target fish mistake for the movement of prey as sensed through the later line system.

### SUMMARY OF THE DISCLOSURE

An embodiment provides a flying fish lure for fishing, the lure having a body and at least two flat elongate appendages attached to the body to approximate the appearance of a flying fish, wherein the body and the appendages are constructed so that the lure floats.

As used herein the term “floats” means that the lure rests on the surface of either salt water or fresh water when there are no external forces acting on the lure and when the water is calm.

The body may be formed with one or more enclosed voids. The lure may include one or more weights. At least one of the weights may be housed within a void formed in the body.

The body may comprise a hard plastic such as acrylonitrile butadiene styrene (ABS).

The at least two appendages may comprise a flexible material such as polyvinyl chloride (PVC).

The two appendages may be manually removable and/or insertable from or to the body. Each of the two appendages may be separately removable and/or insertable from or to the body.

Each of the at least two appendages may be attached to the body at a respective appendage mount, and the appendage mounts may be symmetrically disposed on the body.

The body may have two gill areas and the appendage mounts may be located proximate to respective gill areas. The appendage mounts may be located slightly behind respective gill areas.

The body may have a left side and a right side and may comprise a lateral line located on each of the left side and on the right side, wherein the appendage mounts may be located below respective lateral lines. The mount may extend over the lateral line but a mid-point of the mount, measured in a vertical direction, may be located below the respective lateral line.

The flying fish lure may further comprise two additional, minor appendages. The minor appendages may resemble pelvic fins.

The two additional, minor appendages may manually removable and/or insertable.

The flying fish lure may further comprise a tail. The tail may be made from a flexible material such as polyvinyl chloride (PVC). The tail may be manually removeable and/or insertable. The tail and body may be formed with respective interlocks to prevent movement of the tail relative to the body when inserted.

Each of the two appendages may comprises a rounded underside, when viewed in profile.

Each of the two appendages may comprise a leading edge and a trailing edge and each appendage may be mounted to the body so that the leading edges are closer to an upper surface of the body than the respective trailing edges.

The body may have a lower surface and the lower surface may be substantially flat. The lower surface may be substantially flat when the body is viewed in cross-section. The cross-section may be a width-wise cross-section.

Each of the appendages may be moveable between an operational state and a stowed state.

Each of the appendages may be pivotally mounted to a respective appendage mount and pivotal movement of each appendage may move the respective appendage between the operational state and the stowed state.

The body may comprise a first rigging channel running through the body from a head portion to a rear portion. The first rigging channel may be substantially enclosed other than one or more openings at the head portion and one or more openings at the tail portion.

The first rigging channel may comprise a first opening at the tail portion and two openings at the head portion and wherein a first of said openings at the head portion is located below a second of said openings at the head portion.

The first opening at the tail portion may open into a tail cavity formed in the body to receive a removable tail.

The body may further comprise a second rigging channel, wherein the second rigging portion is a substantially open channel formed in an upper surface of the body.

A method of manufacturing a body for a flying fish lure, the method comprising casting the body in two or more portions, the respective portions including indents and welding the portions together to form the body so that the respective indents form voids within the body. The voids may be substantially airtight. The body may be made from a hard plastic such as ABS. The body may float in water.

### DESCRIPTION OF THE DRAWINGS

Embodiments are herein described, with reference to the accompanying drawings in which:

FIG. 1 is a perspective view of a flying fish lure according to an embodiment in a first configuration;

FIG. 2 is a perspective view of the flying fish lure of FIG. 1 in a second configuration;

FIG. 3 is a top view of the flying fish lure of FIG. 1;

FIG. 4 is a bottom view of the flying fish lure of FIG. 1;

FIG. 5 is an exploded view of the flying fish lure of FIG. 1;

FIG. 6 is a front view of the flying fish lure of FIG. 1;

FIG. 7 is a cross-section along the line 7-7 of FIG. 3;

FIG. 8 is a back view of the flying fish lure of FIG. 1;

FIG. 9 is a cross section along the line 9-9 of FIG. 3;

FIG. 10 is a cross-section of the fishing lure of FIG. 1; and

FIGS. 11 are various rigging arrangements for use with the lure of FIG. 1.

### DETAILED DESCRIPTION OF SPECIFIC EMBODIMENT

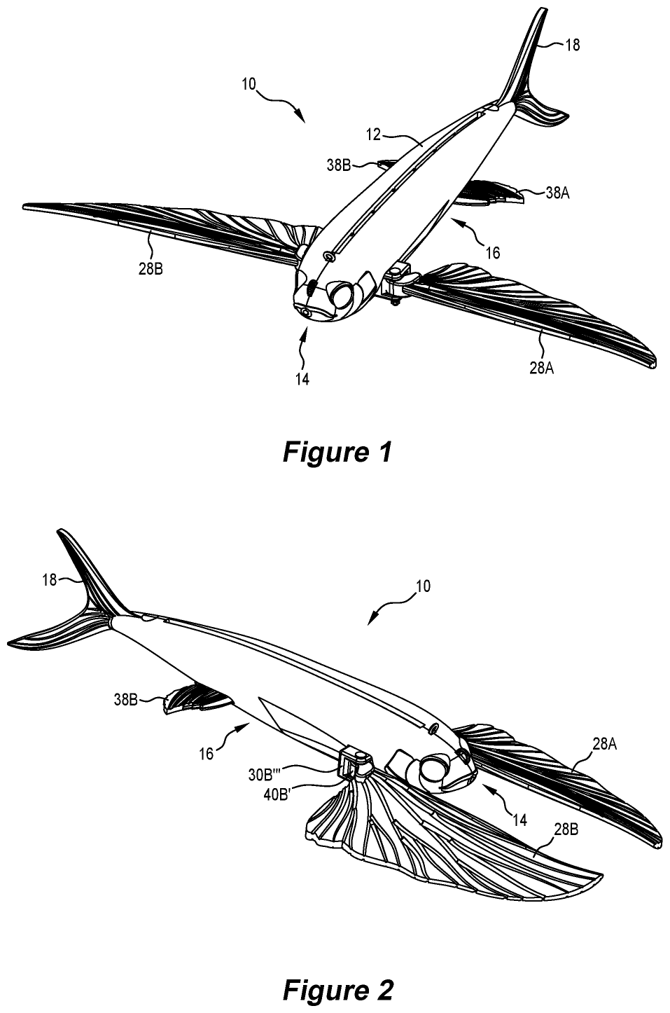

FIGS. 1 to 4 illustrate a flying fish lure 10 according to an embodiment. The lure 10 comprises a body 12 having a head portion 14, a trunk portion 16 and a tail 18. As illustrated, the lure 10 is generally in the shape of a flying fish and therefore includes two wings, a left wing 28A and a right wing 28B. It is to be realised that in a true flying fish, the ‘wings’ are developed lateral fins. However, for the sake of convenience, the term ‘wings’ will be retainer herein.

As illustrated in FIGS. 1 and 2, the wings 28A and 28B are moveable between an operational state (shown in FIG. 1) and a stowed state (shown in FIG. 2).

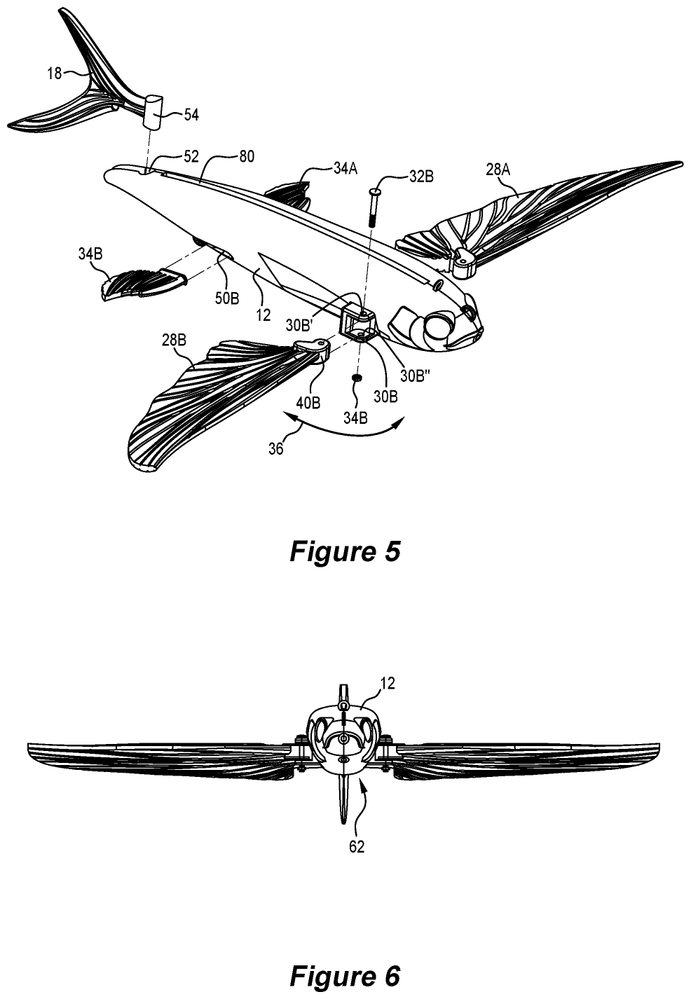

FIG. 5 is an exploded view of the flying fish lure 10 of FIGS. 1 to 4. As shown, the right wing 28B is mounted to the body 12 at left wing mount 30B. Right wing 28A includes a base 32B which is shaped to be received in, and pivot relative to, the left wing mount 30B. The wing mount 30B has two holes 30B′ and 30B″ formed therein and base 32B has hole 34B′ formed therein. A pin 32B secures the wing 28B to the body 12 by locating through the holes 30B′, 30B′ and 34B′.

A stop 34B secures the pin 32B in place to ensure that the wing 28B is able to pivot relative to the body 12 without dislocating the pin. In this embodiment, the stop 34B is formed from a deformable plastic. This may allows a user to easily replace or install new wings onto the body without the use of tools. This, in turn, may allow for user maintenance while fishing, without the need to carry tools and numerous spare parts along. Although the attachment of the right wing 28B to the body 12 has been described, it is to be realised that a similar arrangement secures the left with 28A to the body 12 and the arrangements are symmetrical.

As illustrated in FIG. 5, the pins secure the wings 28A and 28B to the body 12 and allow the wings to pivot relative to the body, as shown by arrow 36 in FIG. 5. The wings 28A and 28B are therefore moveable, relative to the body 12, between an operational position, shown in FIG. 1, for example, and a stowed position, shown in FIG. 2, for example.

As illustrated in FIG. 2, the wing mount 30B is formed with a step 30B′″ and the wing base 40B is formed with a corresponding step 40B′. The steps 30B′″ and 40B′ are shaped to engage one another and prevent movement of the wing 28A past the position in FIG. 2. This may prevent the wing from pivoting too far back which may deleteriously affect the performance of the lure.

Providing for collapsible wings and, in particular, wings which collapse forwards may provide for a lure where the wings collapse once a fish engages with a hook attached to the lure. The hook may be attached to a line where the line is frictionally engaged with the lure so that a force of a fish being snared by the hook causes the line to partially disengage from the line so that the lure can move freely along the line to avoid the fish damaging the lure. By providing collapsible wings, the drag of the lure may be reduced, thereby potentially facilitating the movement of the lure along the line. Furthermore, when the wings are in the stowed position they may be less susceptible to damage as the fish is reeled in.

FIG. 5 further illustrates that the pelvic fins 34A and 34B, as well as the tail 18, may be removed from the body and re-inserted (preferably by a user). To this end, the body 12 includes two voids 50A and 50B which are shaped to accommodate a base of the respective tail fin. For example, with reference to the right pelvic fin 34B, this includes a base 34B′. The base 34B′ and the corresponding void 50B are shaped so that the base 34B′ is accommodated by the void 50B in a friction fit. Furthermore, as described in detail below, the pelvic fins may be constructed from a relatively soft slightly malleable material which may increase the friction of the fit over other materials.

In a similar manner, the body 12 is formed with a tail void 52 having a bulbous formation. The tail 18 is formed with a tail bulb 54. As illustrated in FIG. 5, the tail 8 is partially accommodated by the tail void 52 formed in the body and the tail bulb 54 locates in the bulbous portion of the void, preventing movement of the tail as the lure 10 moves through the water. The tail 18 is engaged with the body 12 with a friction fit. Furthermore, since the tail 18 may be constructed from the same malleable material as the pelvic fins, this may assist with the friction fit.

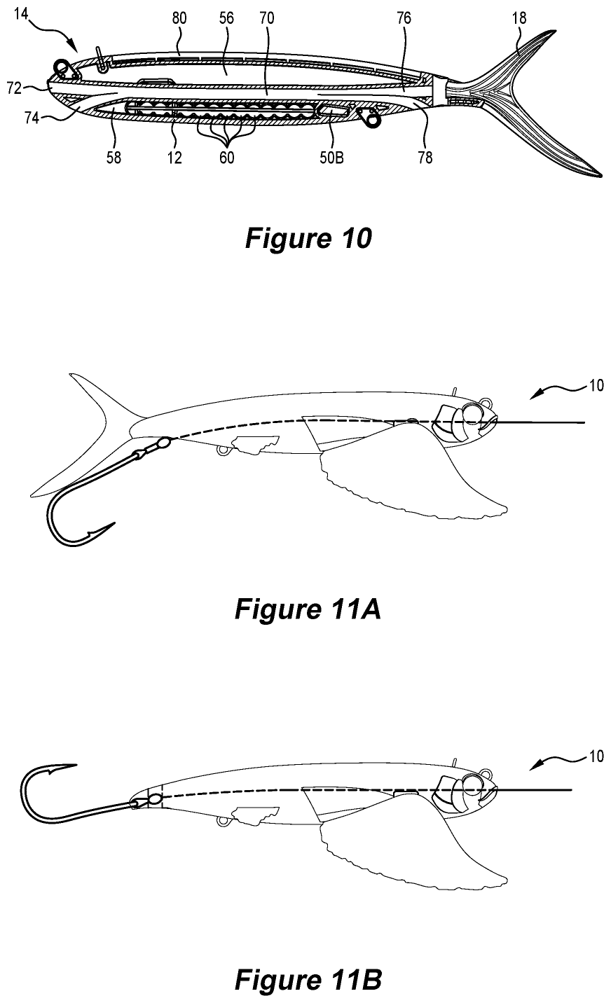

FIGS. 6 and 10 illustrated the body 12 in cross-section. As shown, the body 12 is formed with two voids, an upper void 56 and a lower void 58. The voids 56 and 58 are airtight and provide buoyancy to the lure 10.

It may increase the performance of a fishing lure if it appears life-like to the fist which that lure is intended to catch. The lure of embodiments of the invention is shaped as a flying fish and may imitate aspects of the behaviour of flying fish. A flying fish will use its wings to glide through the air while propelling itself along using its tail. It may therefore be important that the flying fish lure of embodiments stays above the water line (i.e. floats). This will present the silhouette of a flying fish to those fish swimming through the water who consider the flying fish prey. Fish such as tuna and marlin prey on flying fish and it is these kinds of fish which the lure according to embodiments is intended to catch.

The airtight voids 56 and 58 may help the lure 10 to float and therefore may assist in providing a more effective lure.

Since, as discussed, the fish which the lure of embodiments are intended to catch are relatively large fish, they tend to be stronger than smaller fish. It may therefore be desirable to make the lure more resilient. Less dense materials tend to float which may be desirable, but wear less well than harder, denser materials. By constructing the body from a harder material which is denser than water, but which is formed with voids to improve buoyancy, a balance between performance and longevity may be struck.

In an embodiment, the body is constructed from a hard plastic such as acrylonitrile butadiene styrene (ABS). In an embodiment, the body of the lure is made from two portions which are ultrasonically welded together. This may provide for the formation of airtight voids within the body. For example, the body 12 of the lure 10 illustrated is made in two halves, one of which is illustrated in FIG. 10, which are then ultrasonically welded together to form the voids 56 and 58.

The appendages of the lure such as the wings, pelvic fins and tail, may be formed of a lighter, softer material such as a plastic. In an embodiment, the appendages are formed from polyvinyl chloride (PVC) which is flexible and malleable, and which may therefore assist in the friction fits between the appendages and the body. Furthermore, since the shape of the appendages is more likely to present resistance to movement through the water than that of the body, a more flexible material may provide less resistance as the lure is moving through the water since the appendages are then able to flex with their interaction with the water.

It is to be realised that the lure 10 may be made according to different sizes for different fishing applications. In order to balance the buoyancy provided by the voids, the lure may be provided with one or weights. In the embodiment illustrated, the lower void 58 is provided with a number of rounded receptacles 60 which house weights in the form of lead balls (not shown). By providing a number of receptacles, the buoyancy of the lure can be adjusted according to the size of the lure, maintaining the same shape for different sizes. Furthermore, the rounded receptacles may prevent the balls from hitting each other as the lure moves which may create an undesirable noise.

As previously discussed, the flying fish lure may be more effective when it mimics an actual flying fish. In use, the flying fish lure of embodiments may be trawled behind a boat or towed by a kite. Certain anglers prefer different types of fishing and it may be advantageous to provide a flying fish lure which is effective when trawled by a boat and when towed by kite, which employ very different speeds. For this reason too (as well those previously presented) a flying fish lure which floats, and which does not rely on its speed through the water to mimic a flying fish action may be beneficial.

Furthermore, the action of flying fish lures when moving through the water at different speeds may be important. It may be desirable to provide a flying fish lure which mimics the movement of a flying fish both at trawling speeds and kite towing speeds. There are a number of factors which may influence the behaviour of lures according to embodiments when moving through the water.

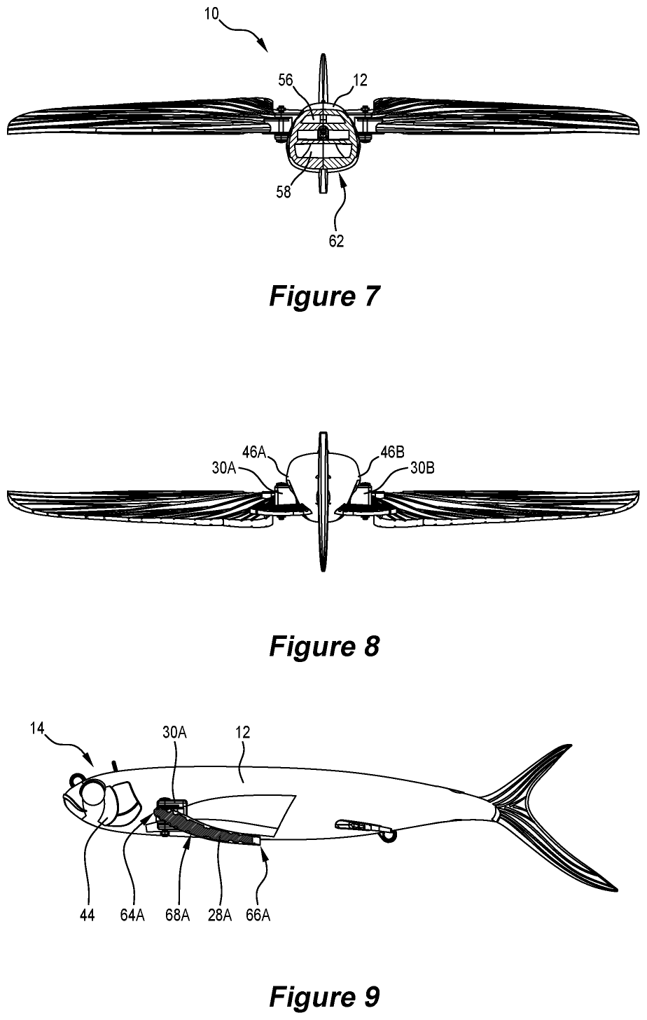

Firstly, as shown in FIGS. 6 and 7, the body 12 has an underside 62 which is the surface which is primarily in contact with the water surface as the lure moves through the water. It has been found that providing a relatively flat underside 62 to the body 12 may assist in keeping the lure stable when moving through the water.

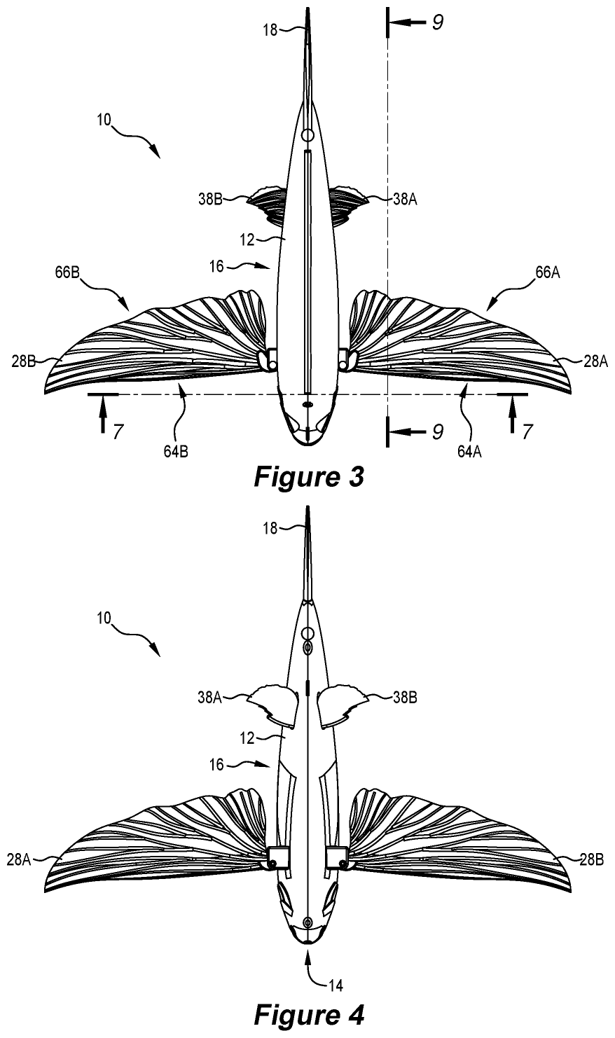

Secondly, it has been found that the shape and orientation of the wings may influence the movement of lures through the water. With reference to the left wing 28A as illustrated in FIGS. 3 and 9, the wing 28A includes a leading ledge 64A and a trailing edge 66A. FIG. 9, which is a cross-section through the line 9-9 of FIG. 3, shows that the wing 28A, when in the operational position, is shaped and mounted to the body 12 so that the leading edge 64A of the wing 28A is higher than the trailing edge 66a (with reference to the directions of FIGS. 9).

By providing the leading edge higher than the trailing edge embodiments may help to ensure that the underside of the wing hits the surface of the water first. This may help prevent the leading edge of the wing from engaging first with the surface of the water, which may cause the wing to ‘dig’ into the water, causing the lure to spin and behave erratically when moving through the water.

Thirdly, as illustrated in FIG. 9, the underside 68A of wing 28A is curved, presenting a convex surface to the water as the lure moves through the water. This too may assist in preventing erratic movement as the lure moves through the water.

Fourthly, as previously described the wings 28A and 28B move between the stowed position and the operational position by pivoting away from the body. The wing mounts and wings are formed with co-operating stops so that the wing is discouraged from moving past the operational state. As the lure of embodiments moves through the water, the wings are encouraged, the movement of the water past the lure, into the operational position, and maintained in that position. This too may help to orientate the wing relative to the body to avoid erratic movement through the water.

Fifthly, the connection point between the wings and the body may influence the behaviour of the lure in the water. In the embodiment illustrated, the body 12 includes a gill area corresponding with the locations of the gills of a flying fish. With reference to FIG. 9, the body 12 includes a left gill area 44A visible in this Figure. The gill area is located towards the back of the head portion. The left wing mount is located on the body so that the wing 28 in the operational position (as illustrated in FIG. 9) is orientated with its leading edge behind the gill area 44A. In this embodiment, this is achieved by having the wing mount 30A located proximate to, and behind, the fill area 44A.

Sixthly, the wing mounts are, as shown in FIG. 8, located below respective lateral lines. In the embodiment illustrated, the lateral lines (respective left lateral line 46A and right lateral line 46B) are the lines on the body of maximum width. It is to be realised that this may not correspond to a location of a lateral line on a living fish. In a further embodiment, the mounts for the wings may extend over the later line. The wings may be mounted so that an upper extent of the wing, in the operation position, is located below the respective lateral line.

These six factors (and others) may assist in providing a lure which is more effective at mimicking a living flying fish, but it is to be realised that lures according to further embodiments may include some, or none, of these features.

Referring back to FIG. 10, the body 12 of the lure is formed with an enclosed channel 70 which extends through the body 12 from the head portion to the tail 18. At both the head region and the tail region, the channel splits, forming two head channels 72 and 74 and two tail channels 76 and 78. The head channel 72 opens out at the nose of the body 12 whereas the head channel 74 opens out at a location below the nose. The tail channel 76 opens out into the bulbous recess 52 (see FIG. 5) which accommodates the tail.

The channel 70 therefore creates a number of different pathways for a line to be engaged with the lure 10. In this manner the lure may be used without the tail 18 if desired by utleising pathway 76, or with the tail 18 by utilizing pathway 78. The head channels 72 and 74 may produce different behaviour for the lure when being trawled and a user may select the desired pathway for their rigging depending on a number of factors such as the speed at which they are trawling.

As further illustrated, the body 12 is formed with an open channel 80 at the top of the body 12. An open channel provided at the top of the body, provides for the type of rigging which hides the line from the target fish, and allows the lure to be used with kite fishing.

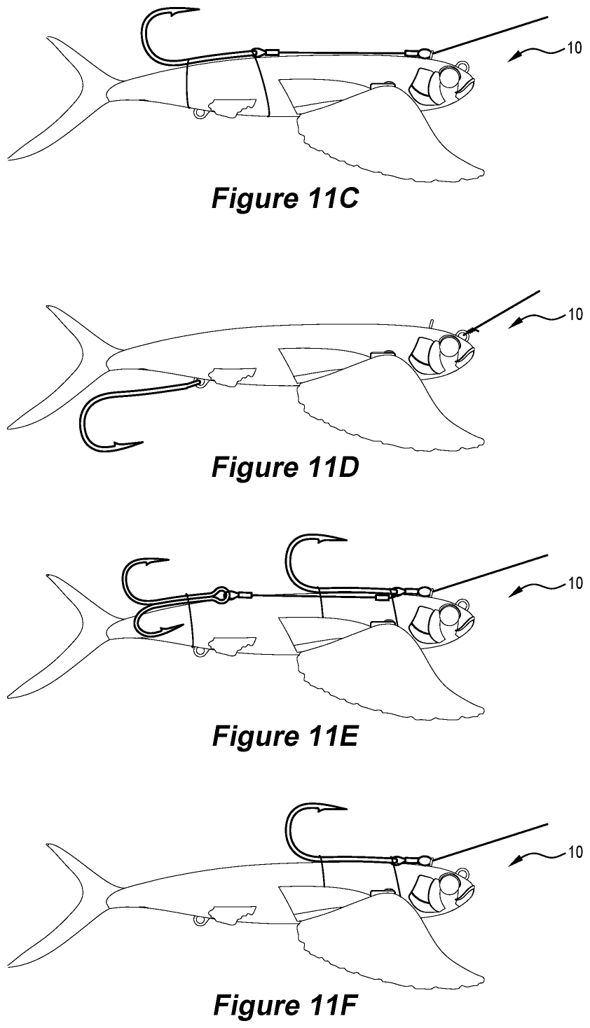

FIGS. 11A to F illustrate various rigging arrangements which may be used with the lure 10 of an embodiment. FIGS. 11A and 11B illustrate rigging arrangements which may be used for trawling. As shown, the arrangement of FIG. 11A uses the channel 78 with the tail 18 present whereas the arrangement of FIG. 11B uses the channel 76 without the tail 18. Although both of the arrangements of FIGS. 11A and 11B show the line exiting the body of the lure through the nose, using channel 72, it is to be realised that channel 74 could be used instead.

As shown in FIGS. 11D, 11E and 11F, a potential advantage of an open channel located at the top of the body may be that the positioning of the hooks along the length, as well as the number of hooks, can be selected by the user. Various eyelets provided on the body assist with the riging.

In a further embodiment, not illustrated, each of the wings may be collapsible in a fan-like structure.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments. Similarly, the word “device” is used in a broad sense and is intended to cover the constituent parts provided as an integral whole as well as an instantiation where one or more of the constituent parts are provided separate to one another.

It is to be understood that, if any prior art publication is referred to herein, such reference does not constitute an admission that the publication forms a part of the common general knowledge in the art, in Australia or any other country.

### LIST OF REFERENCES

Flying fish lure 10
Body 12
Head portion 14
Trunk portion 16
Tail 18
Voids 24
Weights 26
Left wing 28A
Right wing 28B
Left wing mount 30A
Right wing mount 30B
Left wing base 40A
Right wing base 40B
Left wing pivot pin 32A
Right wing pivot pin 32B
Left pin stop 34A
Right pin stop 34B
Arrow 36
Left gill area 44A
Right gill area 44B
Left lateral line 46A
Right lateral line 46B
Left pelvic fin 48A
Right pelvic fin 48B
Left pelvic fin void 50A
Right pelvic find void 50B
Tail fin void 52
Tail fin bulb 54
Upper void 56
Lower void 58
Weight receptacles 60
Body underside 62
Left wing leading edge 64A
Left wing trailing edge 66A
Right wing leading edge 64B
Right wing trailing edge 66B
Left wing underside 68A
Right wing underside 68B
Enclosed rigging channel 70

1. A flying fish lure for fishing, the lure having a body and at least two flat elongate appendages attached to the body to approximate the appearance of a flying fish, wherein the body and the appendages are constructed so that the lure floats.

2. The flying fish lure according to claim 1 wherein the body is formed with one or more enclosed voids.

3. The flying fish lure according to claim 1 wherein the body is constructed from a hard plastic.

4. The flying fish lure according to claim 1 wherein the at least two appendages are comprised of a flexible material.

5. The flying fish lure according to claim 1 wherein the at least two appendages are manually removable from the body.

6. The flying fish lure according to claim 1 wherein each of the at least two appendages is attached to the body at a respective appendage mount, and wherein the appendage mounts are symmetrically disposed on the body.

7. The flying fish lure according to claim 6 wherein the body has two gill areas and wherein the appendage mounts are located proximate to respective gill areas.

8. The flying fish lure according to claim 6 wherein the body has a left side and a right side and wherein the body comprises a lateral line located on each of the left side and on the right side, and wherein the appendage mounts are located below respective lateral lines.

9. The flying fish lure according claim 1 further comprising two additional, minor appendages.

10. The flying fish lure according to claim 9 wherein the two additional, minor appendages are manually removable.

11. The flying fish lure according to claim 1 further comprising a tail

12. The flying fish lure according to claim 1 wherein each of the two appendages comprises a rounded underside, when viewed in profile.

13. The flying fish lure according to claim 1 wherein each of the two appendages comprises a leading edge and a trailing edge wherein each appendage is mounted to the body so that the leading edges are closer to an upper surface of the body than the respective trailing edges.

14. The flying fish lure according to claim 1 wherein the body has a lower surface and wherein the lower surface is substantially flat.

15. The flying fish lure according to claim 1 wherein each of the appendages is moveable between an operational state and a stowed state.

16. The flying fish lure according to claim 13, wherein;
each of the at least two appendages is pivotally mounted to a respective appendage mount,
the appendage mounts are symmetrically disposed on the body, and
pivotal movement of each appendage moves the respective appendage between an operational state and a stowed state.

17. The flying fish lure according to claim 1 wherein the body comprises a first rigging channel running through the body from a head portion to a rear portion.

18. The flying fish lure according to claim 17 wherein the first rigging channel comprises a first opening at the tail portion and two openings at the head portion and wherein a first of said openings at the head portion is located below a second of said openings at the head portion.

19. The flying fish lure according to claim 18 wherein the first opening at the tail portion opens into a tail cavity formed in the body to receive a removable tail.

20. The flying fish lure according to claim 17 wherein the body further comprises a second rigging channel, wherein the second rigging portion is a substantially open channel formed in an upper surface of the body.

21. A method of manufacturing a body for a flying fish lure, the method comprising casting the body in two or more portions, the respective portions including indents and welding the portions together to form the body so that the respective indents form voids within the body.
